(19) United States
(12) Patent Application Publication
(10) Pub. No.: US 2024/0345608 A1
(43) Pub. Date: Oct. 17, 2024

(54) REGULATOR CIRCUIT AND OPERATIONAL AMPLIFIER FOR GENERATING HIGH VOLTAGE SIDE REFERENCE POTENTIAL

(71) Applicant: TRITIUM ELECTRONICS PTE. LTD., Singapore (SG)

(72) Inventors: Zhi-Xin Chen, Hsinchu (TW); Tse-Ju Liao, Hsinchu (TW)

(21) Appl. No.: 18/629,981

(22) Filed: Apr. 9, 2024

Related U.S. Application Data
(60) Provisional application No. 63/495,772, filed on Apr. 12, 2023.

(51) Int. Cl. G05F 1/56

(52) U.S. Cl. CPC G05F 1/56

(57) ABSTRACT

A regulator circuit for generating a high voltage side reference potential comprises: a high voltage side differential input stage for generating a differential current pair according to a difference between a positive terminal input voltage and a negative terminal input voltage; a low voltage side gain stage with transresistance to convert the differential current pair into a transresistance output voltage; and an output amplification stage circuit to amplify the transresistance output to generate an output voltage. The high voltage side differential input stage and the output amplification stage circuit are powered by a high and a low voltage power rails respectively. The regulator circuit regulates the output voltage to a predetermined target voltage higher than a withstand voltage of at least one device in the low voltage side gain stage circuit, according to a difference between a feedback voltage related to the output voltage and a reference voltage.

### CROSS REFERENCE

The present invention claims priority to U.S. 63/495,772 filed on Apr. 12, 2023.

### BACKGROUND OF THE INVENTION

### Field of Invention

The present invention relates to a regulator circuit and an operational amplifier for generating a high voltage side reference potential. Specifically, it relates to such regulator circuit and operational amplifier capable of directly converting a high voltage side differential input voltage into a differential current pair and directly converting the differential current pair with a low voltage side gain stage circuit to generate a high voltage side reference potential.

### Description of Related Art

FIG. 1 shows a typical high voltage battery management system 100. The high voltage battery management system 100 comprises a metal oxide semiconductor field effect transistor (MOSFET) unit 110, a switch operation circuit 121, a low voltage drop circuit 122, and a regulator circuit 130. The MOSFET unit 110 is used to control charging and discharging a high voltage battery 140. The switch operation circuit 121 controls the MOSFET unit 110. The low voltage drop circuit 122 includes circuits that operate in a low voltage power rail due to some devices having a lower withstand voltage, such as logic circuits. The regulator circuit 130, powered by the high voltage power rail, provides a high voltage side reference potential HVREG to the low voltage drop circuit 122, allowing the devices in the low voltage drop circuit 122 that need to operate in a low voltage power rail to be powered by a low voltage power rail formed by the high voltage VDDH and the high voltage side reference potential HVREG. In the case of the high voltage battery management system 100 shown in FIG. 1, the high voltage power rail is formed by the high voltage VDDH and the ground potential GND, providing a power source with a high voltage; conversely, the low voltage power rail is formed by the high voltage VDDH and the high voltage side reference potential HVREG, providing a power source with a low voltage. For example, the voltage at pin VBAT is electrically connected to the high voltage VDDH at 100V when the MOSFETs in the MOSFET unit 110 are ON; the voltage at the ground potential GND is 0V, and the high voltage side reference potential HVREG is 95V. Thus, the devices in the low voltage drop circuit 122 that need to operate in a low voltage power rail operate between 100V and 95V to avoid damage.

The term “low voltage” primarily refers to voltages in digital or analog circuits not used for direct power operations. The low voltage typically denotes a voltage range that supports the normal operation of digital or analog circuits, and the voltage range is relatively lower because the design of digital or analog circuits aims to minimize power consumption while maintaining high-speed operation. For example, in modern digital circuits, low voltage operation ranges can vary from several hundred millivolts (mV) to several volts (V). Some applications might use 5V, 3V, 1.8V, 1.2V, or even lower operating voltages.

Conversely, the term “high voltage” mainly pertains to operating voltages in power circuits, indicating voltage ranges the power circuits are designed to handle or control. These power circuits are often used in applications like electric power conversion and driving large current loads, hence their operating voltages are relatively higher. For example, some power applications might use 12V, 15V, 60V, 120V, 33 kV, and in some cases, such as battery management systems for electric vehicles or large power supplies, this range might be even higher.

As semiconductor technology advances, the definitions of low and high voltages are constantly evolving. For instance, as process technology progresses, the operating voltage of digital circuits continues to decrease, circuits are expanding their voltage handling range to increase efficiency and reliability.

FIG. 2 shows a schematic diagram of a prior art regulator circuit. The regulator circuit shown in FIG. 2 generates an output voltage VO, serving as a high voltage side reference potential provided to an external circuit. Herein, the transistor MP1 is a P-type high voltage transistor, acting as a source follower. The transistor MP1 also serves as the primary output stage, generating the output voltage VO as a high voltage side reference potential, and controls the output voltage VO at the high voltage side reference potential VREFH plus a threshold voltage VTH of the transistor MP1. The transistor MN1 generates a current I to provide the high voltage side reference potential VREFH, wherein the high voltage side reference potential VREFH equals the high voltage VDDH minus the current I multiplied by the resistance R1 on the high voltage side. However, since the regulator circuit shown in FIG. 2 is an open-loop circuit, the output voltage VO is easily affected by process variations and temperature, leading to a decrease in its level accuracy.

To meet demand for high accuracy, a regulator circuit with closed-loop control as shown in FIG. 3 is used to provide a high voltage side reference potential to an external circuit. The regulator circuit shown in FIG. 3 generates the output voltage VO as a high voltage side reference potential. As shown in FIG. 3, the regulator circuit receives the output voltage VO and the high voltage side reference potential VREFH, and inputs them into a level shifter 101, wherein the output voltage VO serves as the feedback voltage. The level shifter 101 performs level shifting on both the feedback voltage and the high voltage side reference potential VREFH, correspondingly generating a relatively lower level low voltage side feedback voltage VOL and a low voltage side reference voltage VREFL. Then, the low voltage side reference voltage VREFL and the low voltage side feedback voltage VOL are input into a low voltage side differential voltage input stage circuit 102. The low voltage side differential voltage input stage circuit 102, as an error amplifier shown in FIG. 3, operates an N-type transistor MN2 on the high voltage side according to the difference between the low voltage side reference voltage VREFL and the low voltage side feedback voltage VOL, to generate the output voltage VO, serving as a high voltage side reference potential. Here, the low voltage side differential voltage input stage circuit 102 is powered by a low voltage power rail formed by the low voltage VDDL and the ground potential. However, in the prior art regulator circuit shown in FIG. 3, not only does the level shifter 101 occupy a large area within the overall regulator circuit, but due to circuit mismatches, it is prone to producing an offset when converting high voltage to low voltage, resulting in a decrease in the accuracy of the output voltage VO level.

In view of the above, the present invention proposes a regulator circuit and operational amplifier capable of directly converting a high voltage side differential input voltage into a differential current pair and then directly converting this differential current pair with a low voltage side gain stage circuit to generate a high voltage side reference potential. This approach aims to enhance the accuracy of the high voltage side reference potential without the need for the extensive use of level shifting circuits, thereby minimizing area consumption and improving level accuracy by reducing potential mismatches and offsets in the conversion process.

### SUMMARY OF THE INVENTION

In one perspective, the present invention provides a regulator circuit for generating a high voltage side reference potential, comprising: a high voltage side differential voltage input stage circuit configured to operably generate a differential current pair according to a difference between a positive terminal input voltage and a negative terminal input voltage; a low voltage side gain stage circuit having a transresistance to convert the differential current pair into a transresistance output voltage; and an output amplification stage circuit configured to operably amplify the transresistance output voltage to generate an output voltage; wherein the high voltage side differential voltage input stage circuit and the output amplification stage circuit are powered by a high voltage power rail, and the low voltage side gain stage circuit is powered by a low voltage power rail; wherein the regulator circuit adjusts the output voltage to a predetermined target voltage according to the difference between a feedback voltage related to the output voltage and a reference voltage, wherein the predetermined target voltage is higher than a withstand voltage of at least one device in the low voltage side gain stage circuit; wherein the feedback voltage and the reference voltage correspond respectively to one and the other of the negative terminal input voltage and the positive terminal input voltage; wherein the output voltage serves as a high voltage side reference potential for an external circuit; wherein a difference between the positive terminal input voltage and the negative terminal input voltage is a high voltage side differential input voltage.

In another perspective, the present invention provides an operational amplifier, comprising: a high voltage side differential voltage input stage circuit configured to operably generate a differential current pair according to the difference between a positive terminal input voltage and a negative terminal input voltage; a low voltage side gain stage circuit having a transresistance, configured to operably convert the differential current pair into a transresistance output voltage; and an output amplification stage circuit configured to operably amplify the transresistance output voltage to generate an output voltage; wherein the high voltage side differential voltage input stage circuit and the output amplification stage circuit are powered by a high voltage power rail, and the low voltage side gain stage circuit is powered by a low voltage power rail; wherein the output voltage serves as a high voltage side reference ground potential for an external circuit; wherein the difference between the positive terminal input voltage and the negative terminal input voltage is a high voltage side differential input voltage.

In one embodiment, the high voltage power rail is formed by a high voltage and a ground potential; wherein the low voltage power rail is formed by a low voltage and the ground potential; wherein the high voltage is higher than the low voltage.

In one embodiment, the high voltage is higher than the withstand voltage of the at least one device in the low voltage side gain stage circuit.

In one embodiment, the low voltage side gain stage circuit includes a transresistance amplifier for transresistance amplifying the differential current pair to generate the transresistance output voltage.

In one embodiment, the regulator circuit further includes a reference voltage generation circuit powered by the high voltage power rail, configured to operably generate the reference voltage according to the high voltage.

In one embodiment, the high voltage side differential voltage input stage circuit includes: a bias circuit configured to operably receive the high voltage and provide a bias current; and a differential pair circuit including a pair of differentially coupled transistors configured to operably differentially distribute the bias current to generate the differential current pair according to the difference between the reference voltage and the feedback voltage, wherein a withstand voltage of the pair of differential transistors is higher than the high voltage.

In one embodiment, the low voltage side gain stage circuit includes: a first current mirror circuit configured to operably mirror a positive terminal current of the differential current pair to generate a first current; and a second current mirror circuit configured to operably mirror a negative terminal current of the differential current pair to generate a second current; wherein the first current mirror circuit and the second current mirror circuit are coupled to each other to generate the transresistance output voltage in a push-pull manner according to the first current and the second current.

In one embodiment, the bias circuit includes a bias resistor coupled between the high voltage and the pair of differential transistors.

In one embodiment, the high voltage is at least twice the low voltage.

In one embodiment, the high voltage is at least ten times the low voltage.

In one embodiment, the reference voltage generation circuit includes a resistor and a current source connected in series.

In one embodiment, the regulator circuit further includes a clamping circuit coupled between the high voltage side differential voltage input stage circuit and the low voltage side gain stage circuit, configured to operably clamp a voltage received by the low voltage side gain stage circuit from the high voltage side differential voltage input stage circuit not to exceed a predetermined clamping voltage, wherein the predetermined clamping voltage is lower than the withstand voltage of at least one device in the low voltage side gain stage circuit.

In one embodiment, the regulator circuit for generating a high voltage side reference voltage does not include a level shifting amplifier circuit, and the level shifting amplifier circuit is configured to operably perform level shifting and amplification on the feedback voltage and the reference voltage respectively, to generate the transresistance output voltage; wherein the level shifting amplifier circuit includes a level shifting circuit and a low voltage side differential voltage input stage circuit; wherein the level of the feedback voltage and the reference voltage is higher than the withstand voltage of the low voltage side differential voltage input stage circuit.

The advantages of this invention include area savings, avoidance of voltage offset errors generated by level shifting circuits, and enhanced accuracy of the output voltage.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a typical high voltage battery management system.

FIG. 2 is a schematic diagram of a prior art regulator circuit.

FIG. 3 is a schematic diagram of another prior art regulator circuit.

FIG. 4 is a block diagram of a regulator circuit for generating a high voltage side reference voltage according to one embodiment of the invention

FIG. 5 is a block diagram of a low voltage side gain stage circuit according to one embodiment of the invention.

FIG. 6 is a block diagram of a reference voltage generation circuit according to one embodiment of the invention.

FIG. 7 is a block diagram of a high voltage side differential voltage input stage circuit according to one embodiment of the invention.

FIG. 8 is a block diagram showing the coupling relationship of a clamping circuit according to one embodiment of the invention.

FIG. 9 is a schematic diagram of a regulator circuit for generating a high voltage side reference potential according to a more specific embodiment of the invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale.

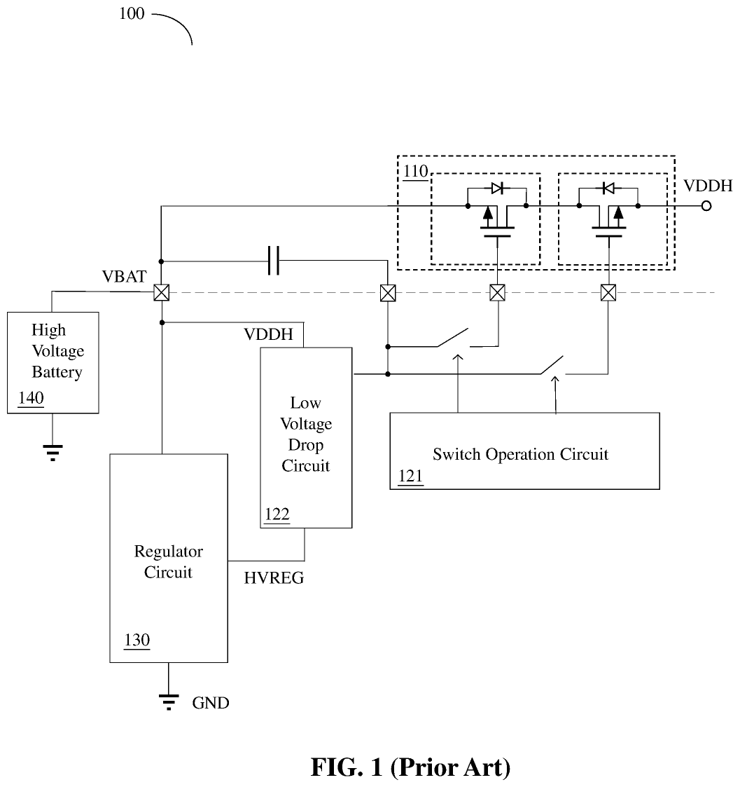

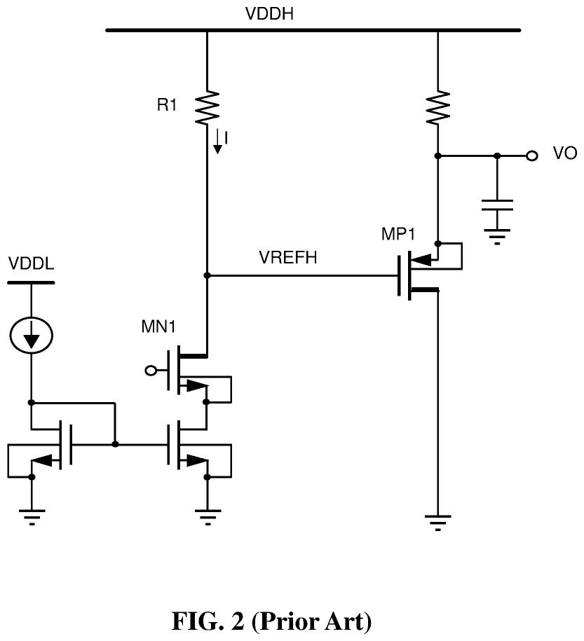

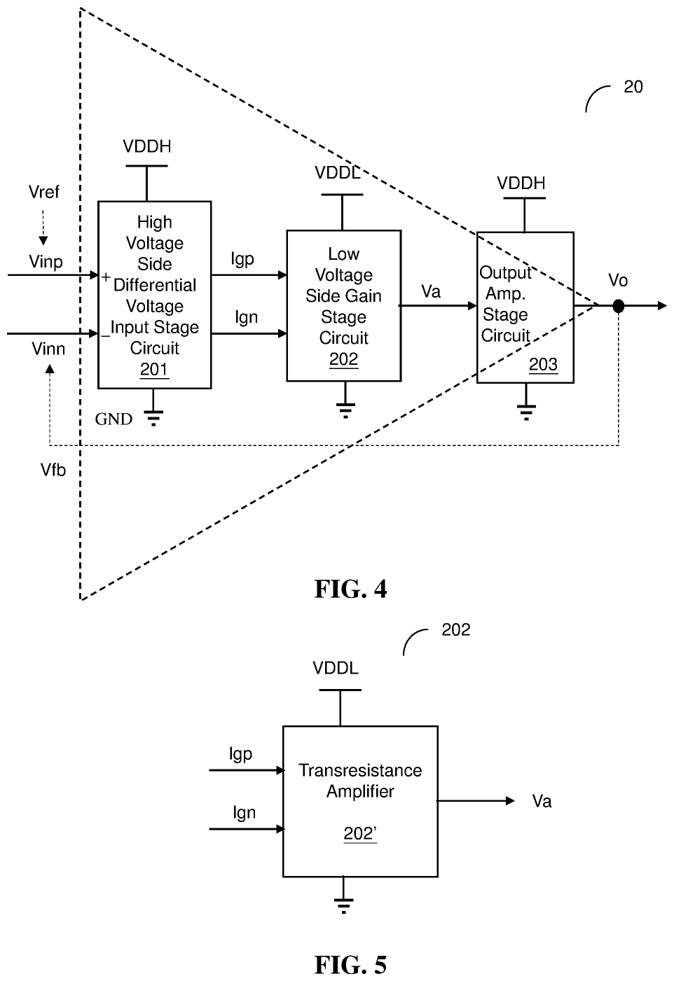

FIG. 4 is a block diagram of a regulator circuit for generating a high voltage side reference potential according to one embodiment of the invention. As shown in FIG. 4, the regulator circuit 20 for generating a high voltage side reference potential includes a high voltage side differential voltage input stage circuit 201, a low voltage side gain stage circuit 202, and an output amplification stage circuit 203. The high voltage side differential voltage input stage circuit 201 generates a differential current pair Igp, Ign according to a difference between the positive input voltage Vinp and the negative input voltage Vinn. The low voltage side gain stage circuit 202, with transresistance, converts the differential current pair Igp, Ign into a transresistance output voltage Va. The output amplification stage circuit 203 amplifies the transresistance output voltage Va to generate an output voltage Vo. The output voltage Vo serves as a high voltage side reference potential (such as but not limited to the high voltage side reference potential HVREG shown in FIG. 1) for an external circuit. Referring to FIG. 4, the high voltage side differential voltage input stage circuit 201 and the output amplification stage circuit 203 are powered by a high voltage power rail, and the low voltage side gain stage circuit 202 is powered by a low voltage power rail. In this embodiment, the high voltage power rail is formed by the high voltage VDDH and the ground potential GND, providing a high voltage power source; conversely, the low voltage power rail is formed by the low voltage VDDL and the ground potential GND, providing a low voltage power source.

Referring further to FIG. 4, the regulator circuit 20 for generating a high voltage side reference potential adjusts the output voltage Vo to a predetermined target voltage according to the difference between the feedback voltage Vfb and the reference voltage Vref. In one embodiment, the predetermined target voltage is higher than a withstand voltage of at least one device in the low voltage side gain stage circuit 202. In one embodiment, the feedback voltage Vfb and the reference voltage Vref correspond respectively to one of the negative input voltage Vinn and the positive input voltage Vinp, as indicated by the dashed arrow in FIG. 4. In this embodiment, for example, the reference voltage Vref serves as the positive input voltage Vinp, and the feedback voltage Vfb serves as the negative input voltage Vinn. In another embodiment, for example, the feedback voltage Vfb serves as the positive input voltage Vinp, and the reference voltage Vref serves as the negative input voltage Vinn. In one embodiment, the high voltage VDDH is higher than the withstand voltage of at least one device in the low voltage side gain stage circuit 202. It should be noted that the regulator circuit of the invention is a linear regulator circuit. It should be mentioned that, in the descriptions of embodiments, all mentions of one voltage being higher or lower than another voltage refer to the comparison of these two voltages relative to the ground potential. It should be mentioned that the reference voltage Vref is predetermined, its predetermined level is related to the predetermined target voltage of the output voltage Vo.

From another perspective, the invention proposes an operational amplifier, which in one embodiment includes the high voltage side differential voltage input stage circuit 201, low voltage side gain stage circuit 202, and output amplification stage circuit 203 shown in FIG. 4, as indicated by the triangular dashed lines in FIG. 4. The operational amplifier of the invention can also be implemented according to the embodiments shown in FIGS. 5, 7, 8, and 9.

Wherein, the high voltage VDDH is different from the low voltage VDDL. In one embodiment, the high voltage VDDH is higher than the low voltage VDDL. In one embodiment, the high voltage VDDH is at least twice the low voltage VDDL. In another embodiment, the high voltage VDDH is at least ten times the low voltage VDDL. Herein, high voltage refers to a level not lower than 10V, while low voltage refers to a voltage lower than the high voltage.

FIG. 5 is a block diagram of a low voltage side gain stage circuit according to one embodiment of the invention. As shown in FIG. 5, the low voltage side gain stage circuit 202 includes a transresistance amplifier 202′ for transresistance amplifying the differential current pair Igp, Ign to generate the transresistance output voltage Va.

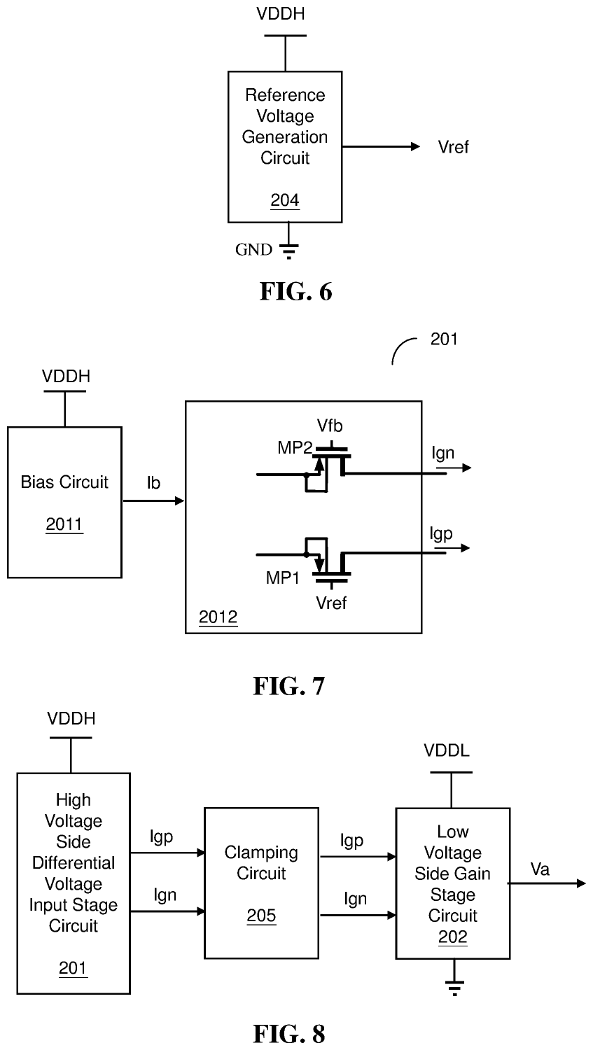

FIG. 6 is a block diagram of a reference voltage generation circuit according to one embodiment of the invention. As shown in FIG. 6, the reference voltage generation circuit 204 is powered by the high voltage power rail formed by the high voltage VDDH and the ground potential GND. The reference voltage generation circuit 204 generates the reference voltage Vref.

FIG. 7 is a block diagram of a high voltage side differential voltage input stage circuit according to one embodiment of the invention. As shown in FIG. 7, the high voltage side differential voltage input stage circuit 201 includes a bias circuit 2011 and a differential pair circuit 2012. The bias circuit 2011 is configured to receive the high voltage VDDH and provide a bias current Ib. The differential pair circuit 2012 comprises a pair of differentially coupled transistors MP1 and MP2, configured to differentially distribute the bias current Ib to generate the differential current pair Igp and Ign according to the difference between the reference voltage Vref and the feedback voltage Vfb, wherein the withstand voltage of the differential transistors MP1 and MP2 is higher than the high voltage VDDH.

FIG. 8 is a block diagram showing the coupling relationship of a clamping circuit according to one embodiment of the invention. As shown in FIG. 8, the regulator circuit of the invention further includes a clamping circuit 205, coupled between the high voltage side differential voltage input stage circuit 201 and the low voltage side gain stage circuit 202, to clamp the voltage received by the low voltage side gain stage circuit 202 from the high voltage side differential voltage input stage circuit 201 not to exceed a predetermined clamping voltage. The predetermined clamping voltage is lower than the withstand voltage of at least one device, such as transistors MN5, MN6, in the low voltage side gain stage circuit 202, which is lower than the predetermined target voltage of the output voltage Vo for devices in the low voltage side gain stage circuit 202.

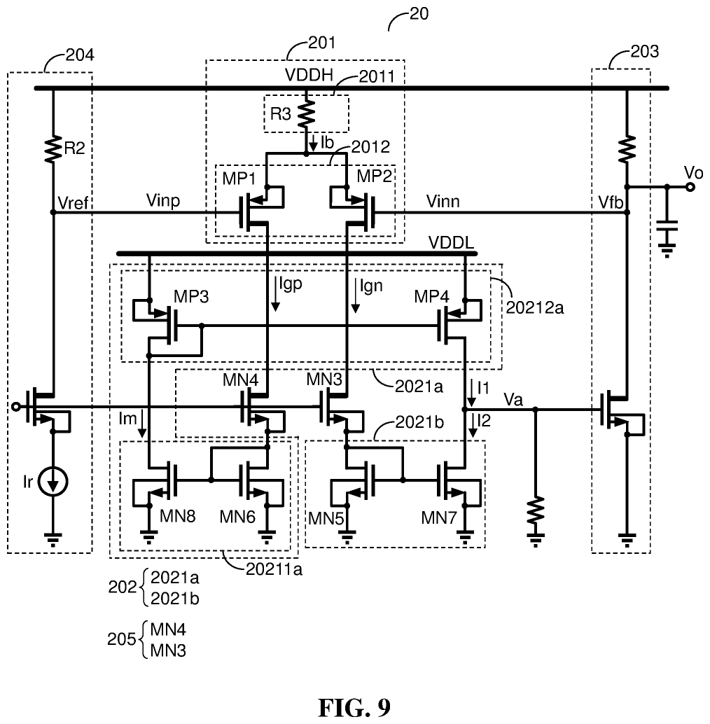

FIG. 9 is a schematic diagram of a regulator circuit for generating a high voltage side reference potential according to one embodiment of the invention. This embodiment is a more specific circuit embodiment of FIG. 4. As shown in FIG. 9, the regulator circuit 20 for generating a high voltage side reference potential includes a high voltage side differential voltage input stage circuit 201, a low voltage side gain stage circuit 202, and an output amplification stage circuit 203.

As shown in FIG. 9, the high voltage side differential voltage input stage circuit 201 generates a differential current pair Igp, Ign according to the difference between the positive input voltage Vinp and the negative input voltage Vinn. The low voltage side gain stage circuit 202 includes a transresistance amplifier to transresistance amplify the differential current pair Ign, Igp to generate the transresistance output voltage Va. The output amplification stage circuit 203 amplifies the transresistance output voltage Va to generate the output voltage Vo. In this embodiment, the regulator circuit 20 for generating a high voltage side reference potential further includes a reference voltage generation circuit 204, powered by the high voltage power rail formed by high voltage VDDH and the ground potential GND, to generate the reference voltage Vref.

In one embodiment, the high voltage side differential voltage input stage circuit 201 includes a bias circuit 2011 and a differential pair circuit 2012. The bias circuit 2011 receives high voltage VDDH and provides a bias current Ib. In this embodiment, the bias circuit 2011 includes a bias resistor R3, coupled between the high voltage VDDH and the differential pair circuit 2012. The differential pair circuit 2012 comprises a pair of differentially coupled transistors and MP2, configured to differentially distribute the bias current Ib according to the difference between the reference voltage Vref and the feedback voltage Vfb to generate the differential current pair Igp and Ign, wherein the withstand voltage of the differential transistors MP1 and MP2 is higher than the high voltage VDDH.

In this embodiment, the low voltage side gain stage circuit 202 includes a first current mirror circuit 2021a and a second current mirror circuit 2021b. The first current mirror circuit 2021a mirrors the positive terminal current Igp of the differential current pair Ign, Igp to generate a first current I1. The second current mirror circuit 2021b mirrors the negative terminal current Ign of the differential current pair Igp, Ign to generate a second current I2.

The first current mirror circuit 2021a and the second current mirror circuit 2021b are coupled to each other to generate the transresistance output voltage Va in a push-pull manner according to the first current I1 and the second current I2. In one embodiment, the first current mirror circuit 2021a may include current mirrors 20211a and 20212a. The current mirror 20211a mirrors the positive terminal current Igp to generate an intermediate current Im, and the current mirror 20212a mirrors the intermediate current Im to generate the first current I1. Transistors MP4 and MN7 act as the output current sources for the first and second current mirror circuits 2021a and 2021b, respectively. Together, they form a push-pull amplifier that generates the transresistance output voltage Va according to the first current I1 and the second current I2.

In this embodiment, the output amplification stage circuit 203 is configured to amplify the transresistance output voltage Va to generate the output voltage Vo. The output amplification stage circuit 203 includes a resistor and a transistor connected in series, coupled between the high voltage VDDH and the ground potential GND. This transistor receives the transresistance output voltage Va to generate the output voltage Vo.

In one embodiment, the reference voltage generation circuit 204 includes a resistor R2 and a current source Ir connected in series between the high voltage VDDH and the ground potential GND, to provide the reference voltage Vref.

The regulator circuit 20 for generating a high voltage side reference potential further includes a clamping circuit 205, according to one embodiment, which is coupled between the high voltage side differential voltage input stage circuit 201 and the low voltage side gain stage circuit 202. This clamping circuit is configured to ensure the voltage received by the low voltage side gain stage circuit 202 from the high voltage side differential voltage input stage circuit 201 does not exceed a predetermined clamping voltage. This predetermined clamping voltage is set lower than the withstand voltage of at least one device, such as transistors MN5, MN6, within the low voltage side gain stage circuit 202, ensuring protection against voltages exceeding the device's withstand voltage.

According to one embodiment, the predetermined target voltage of the output voltage Vo is higher than the withstand voltage of at least one device, such as transistors MN4, MN5, MN6, MN7, MN8, MP3, or MP4, within the low voltage side gain stage circuit 202. In this embodiment, the high voltage VDDH is higher than the withstand voltage of at least one of these devices.

As illustrated in the embodiment shown in FIG. 9, the regulator circuit 20 for generating a high voltage side reference potential according to the invention does not include a level shifting amplifier circuit. This level shifting amplifier circuit, if present, would perform level shifting on the feedback voltage Vfb and the reference voltage Vref before amplifying the difference between the level-shifted feedback voltage Vfb and level-shifted reference voltage Vref to generate the transresistance output voltage Va. The circuit includes a level shifting circuit and a low voltage side differential voltage input stage circuit, wherein the levels of feedback voltage Vfb and reference voltage Vref are higher than the withstand voltage of the low voltage side differential voltage input stage circuit.

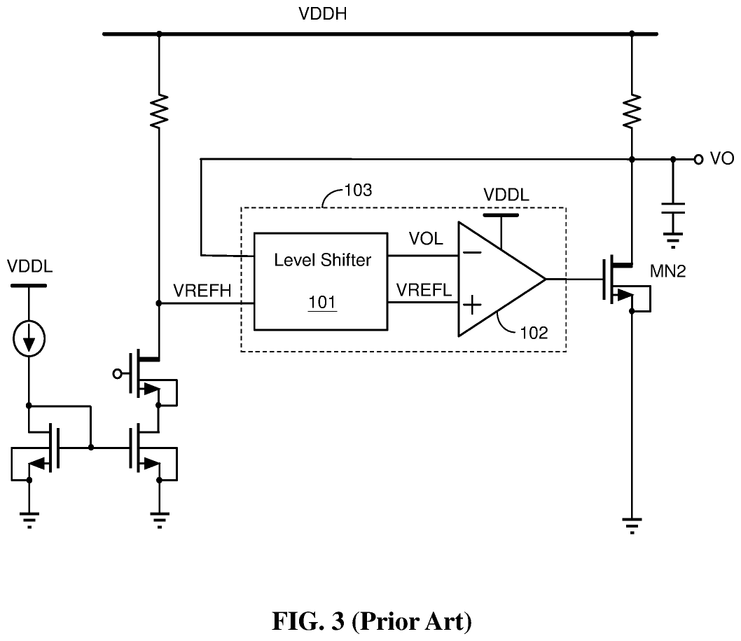

The regulator circuit of the invention eliminates the need for a level shifting amplifier circuit as shown in the prior art of FIG. 3. That is, the regulator circuit of the invention does not require level shifting of the feedback voltage Vfb and the reference voltage Vref; hence, it does not shift the levels of feedback voltage Vfb and reference voltage Vref to lower voltages before amplification to generate the transresistance output voltage Va.

In summary, the invention achieves area savings, avoids voltage offset errors generated by level shifting circuits, and realizes high accuracy with low area requirement.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. The various embodiments described above are not limited to being used alone; two embodiments may be used in combination, or a part of one embodiment may be used in another embodiment. For example, other process steps or structures, such as a metal silicide layer, may be added. For another example, the lithography process step is not limited to the mask technology but it can also include electron beam lithography, immersion lithography, etc. Therefore, in the same spirit of the present invention, those skilled in the art can think of various equivalent variations and various combinations, and there are many combinations thereof, and the description will not be repeated here. The scope of the present invention should include what are defined in the claims and the equivalents.

What is claimed is:

1. A regulator circuit for generating a high voltage side reference potential, comprising:
a high voltage side differential voltage input stage circuit configured to operably generate a differential current pair according to a difference between a positive terminal input voltage and a negative terminal input voltage;
a low voltage side gain stage circuit having a transresistance to convert the differential current pair into a transresistance output voltage; and
an output amplification stage circuit configured to operably amplify the transresistance output voltage to generate an output voltage;
wherein the high voltage side differential voltage input stage circuit and the output amplification stage circuit are powered by a high voltage power rail, and the low voltage side gain stage circuit is powered by a low voltage power rail;
wherein the regulator circuit adjusts the output voltage to a predetermined target voltage according to the difference between a feedback voltage related to the output voltage and a reference voltage, wherein the predetermined target voltage is higher than a withstand voltage of at least one device in the low voltage side gain stage circuit;
wherein the feedback voltage and the reference voltage correspond respectively to one and the other of the negative terminal input voltage and the positive terminal input voltage;
wherein the output voltage serves as a high voltage side reference potential for an external circuit;
wherein a difference between the positive terminal input voltage and the negative terminal input voltage is a high voltage side differential input voltage.

2. The regulator circuit of claim 1, wherein the high voltage power rail is formed by a high voltage and a ground potential;
wherein the low voltage power rail is formed by a low voltage and the ground potential;
wherein the high voltage is higher than the low voltage.

3. The regulator circuit of claim 2, wherein the high voltage is higher than the withstand voltage of the at least one device in the low voltage side gain stage circuit.

4. The regulator circuit of claim 2, wherein the low voltage side gain stage circuit includes a transresistance amplifier for transresistance amplifying the differential current pair to generate the transresistance output voltage.

5. The regulator circuit of claim 1, further comprising a reference voltage generation circuit powered by the high voltage power rail, configured to operably generate the reference voltage according to the high voltage.

6. The regulator circuit of claim 2, wherein the high voltage side differential voltage input stage circuit includes:
a bias circuit configured to operably receive the high voltage and provide a bias current; and
a differential pair circuit including a pair of differential transistors coupled to each other, and configured to operably differentially distribute the bias current to generate the differential current pair according to the difference between the reference voltage and the feedback voltage, wherein a withstand voltage of the pair of differential transistors is higher than the high voltage.

7. The regulator circuit of claim 1, wherein the low voltage side gain stage circuit includes:
a first current mirror circuit configured to operably mirror a positive terminal current of the differential current pair to generate a first current; and
a second current mirror circuit configured to operably mirror a negative terminal current of the differential current pair to generate a second current;
wherein the first current mirror circuit and the second current mirror circuit are coupled to each other to generate the transresistance output voltage in a push-pull manner according to the first current and the second current.

8. The regulator circuit of claim 6, wherein the bias circuit includes a bias resistor coupled between the high voltage and the pair of differential transistors.

9. The regulator circuit of claim 2, wherein the high voltage is at least twice the low voltage.

10. The regulator circuit of claim 9, wherein the high voltage is at least ten times the low voltage.

11. The regulator circuit of claim 5, wherein the reference voltage generation circuit includes a resistor and a current source connected in series.

12. The regulator circuit of claim 1, further comprising a clamping circuit coupled between the high voltage side differential voltage input stage circuit and the low voltage side gain stage circuit, configured to operably clamp a voltage received by the low voltage side gain stage circuit from the high voltage side differential voltage input stage circuit not to exceed a predetermined clamping voltage, wherein the predetermined clamping voltage is lower than the withstand voltage of at least one device in the low voltage side gain stage circuit.

13. The regulator circuit of claim 1, wherein the regulator circuit for generating a high voltage side reference voltage does not include a level shifting amplifier circuit, and the level shifting amplifier circuit is configured to operably perform level shifting and amplification on the feedback voltage and the reference voltage, to generate the transresistance output voltage;
wherein the level shifting amplifier circuit includes a level shifting circuit and a low voltage side differential voltage input stage circuit;
wherein the level of the feedback voltage and the reference voltage is higher than the withstand voltage of the low voltage side differential voltage input stage circuit.

14. An operational amplifier, comprising:
a high voltage side differential voltage input stage circuit configured to operably generate a differential current pair according to the difference between a positive terminal input voltage and a negative terminal input voltage;
a low voltage side gain stage circuit having a transresistance, configured to operably convert the differential current pair into a transresistance output voltage; and
an output amplification stage circuit configured to operably amplify the transresistance output voltage to generate an output voltage;
wherein the high voltage side differential voltage input stage circuit and the output amplification stage circuit are powered by a high voltage power rail, and the low voltage side gain stage circuit is powered by a low voltage power rail;
wherein the output voltage serves as a high voltage side reference ground potential for an external circuit;
wherein the difference between the positive terminal input voltage and the negative terminal input voltage is a high voltage side differential input voltage.

15. The operational amplifier according to claim 14, wherein the high voltage power rail is formed by a high voltage and the ground potential;
wherein the low voltage power rail is formed by a low voltage and the ground potential;
wherein the high voltage is higher than the low voltage.

16. The operational amplifier according to claim 15, wherein the high voltage is higher than a withstand voltage of at least one device in the low voltage side gain stage circuit.

17. The operational amplifier according to claim 14, wherein the low voltage side gain stage circuit includes a transresistance amplifier, configured to operably transresistance amplify the differential current pair to generate the transresistance output voltage.

18. The operational amplifier according to claim 15, wherein the high voltage side differential voltage input stage circuit includes:
a bias circuit configured to operably receive the high voltage and provide a bias current; and
a differential pair circuit including a pair of differential transistors coupled to each other, and configured to operably differentially distribute the bias current to generate the differential current pair according to the difference between the reference voltage and the feedback voltage, wherein a withstand voltage of the pair of differential transistors is higher than the high voltage.

19. The operational amplifier according to claim 14, wherein the low voltage side gain stage circuit includes:
a first current mirror circuit configured to operably mirror a positive terminal current of the differential current pair to generate a first current; and
a second current mirror circuit configured to operably mirror a negative terminal current of the differential current pair to generate a second current;
wherein the first current mirror circuit and the second current mirror circuit are coupled to each other to generate the transresistance output voltage in a push-pull manner according to the first current and the second current.

20. The operational amplifier according to claim 18, wherein the bias circuit includes a bias resistor coupled between the high voltage and the pair of differential transistors.

21. The operational amplifier according to claim 15, wherein the high voltage is at least twice the low voltage.

22. The operational amplifier according to claim 21, wherein the high voltage is at least ten times the low voltage.

23. The operational amplifier according to claim 14, further comprising a clamping circuit coupled between the high voltage side differential voltage input stage circuit and the low voltage side gain stage circuit, configured to operably clamp a voltage received by the low voltage side gain stage circuit from the high voltage side differential voltage input stage circuit not to exceed a predetermined clamping voltage, wherein the predetermined clamping voltage is lower than the withstand voltage of the at least one device in the low voltage side gain stage circuit.

24. The operational amplifier according to claim 14, wherein the operational amplifier does not include a level shifting amplifier circuit, and the level shifting amplifier circuit is configured to operably perform level shifting and amplification on the feedback voltage and the reference voltage, to generate the transresistance output voltage;
wherein the level shifting amplifier circuit includes a level shifting circuit and a low voltage side differential voltage input stage circuit;
wherein the level of the feedback voltage and the reference voltage is higher than the withstand voltage of the low voltage side differential voltage input stage circuit.
